(19) United States
(12) Patent Application Publication
(10) Pub. No.: US 2013/0311074 A1
(43) Pub. Date: Nov. 21, 2013

(54) IGNITION EVENT GENERATION USING DATA FROM VEHICLE BUS

(71) Applicant: Juhani Siira, Burnaby (CA)

(72) Inventor: Juhani Siira, Burnaby (CA)

(73) Assignee: WEBTECH WIRELESS INC., Burnaby (CA)

(21) Appl. No.: 13/473,964

(22) Filed: May 17, 2012

(51) Int. Cl. F02D 28/00

(52) U.S. Cl. 701/113

(57) ABSTRACT

A device detects ignition on and ignition off events in a vehicle with an internal combustion engine. Ignition events are detected by reading data from the vehicle's data bus. While the ignition is off, the device awakes from time to time to either listen to or poll the data bus. Waking of the device may be triggered by the expiry of a timer or by the detection of a voltage fluctuation of the battery which provides power to both the engine and the device.

### TECHNICAL FIELD

The subject matter of the present invention relates to the field of detecting ignition of an internal combustion engine in an automobile. More particularly, this invention is concerned with a device and method for detecting whether the ignition is on or off based upon data obtained from the vehicle's data bus.

### BACKGROUND ART

It is a generally useful feature of location based systems to be able to identify when a vehicle engine is running, this being defined as the engine having its crank actually rotating. In order to determine an engine running period, it is convenient to define “ignition on” and “ignition off” events, where the duration between these events is considered engine running time. The engine running period should not include time when the vehicle ignition key is in an “accessory” position and the electrical system is active, without the engine crank actually rotating.

Ignition on and ignition off events can be determined in a number of existing ways. One method involves running a physical wire to the vehicle ignition system so that when the ignition key is engaged, a voltage change is detected on the ignition wire and the ignition on event is deduced. This method is disadvantageous in that it requires a separate ignition sense wire to be installed and can lead to erroneous engine running times due to the ignition key being in the “accessory” position without the engine running.

Typically the dashboard must be opened to install an ignition sense wire, which results in undesirable installation costs.

Another method is to run an ignition sense wire directly to the alternator to avoid the ignition key “accessory” position problem, but this requires an ignition sense wire to be installed through the vehicle firewall and into the engine compartment.

Yet another method is to observe the power supplied to an electronic device connected to the vehicle's battery, but this can result in a large percentage of extraneous and incorrect ignition on and ignition off events.

Still further, another method is to observe the power supply and use other peripheral data, such as accelerometer and GPS data, or to observe signals, instead of data, received via the vehicle bus alone or in combination with information concerning the vehicle ignition state derived from other sources, to deduce the ignition on and ignition off events, as disclosed in US patent application publication No. 2011/0106373.

### SUMMARY OF THE INVENTION

The present invention allows for the detection of vehicle ignition without requiring a separate ignition wire to be installed. It also solves the problem of the time the ignition key is in the “accessory” position being counted as engine running time.

In an installation where a vehicle bus interface is used or is available (e.g. JBUS, CAN, OBD), the data from the bus can be used to deduce whether the engine is in a running state. For example, the engine rpm can be read, which, when it is greater than zero, indicates that the engine is running. There may be other bus data elements that can be read which correlate directly to the running state of an engine.

When the engine is off, the trigger for reading data from the vehicle data bus may be the expiry of a timer or a detected voltage fluctuation on the battery.

The present invention may be used in the area of telematics, where the operation of a fleet of vehicles is monitored remotely. For example, each vehicle may be fitted with an on-board locating device that also records operating parameters of the vehicle and/or the identity of the driver.

Disclosed herein is a method for generating ignition events in a vehicle equipped with an internal combustion engine, the method comprising the steps of: waking, from a state of sleep, a device connected to a data bus in the vehicle; the device, while woken, attempting to obtain first data from the data bus; interpreting, by a processor in the device, the obtained first data or an absence of first data as either the engine running or not running; if the engine is interpreted not to be running, returning the device to the state of sleep; and if the engine is interpreted to be running: generating an ignition on event including a corresponding time of the ignition on event; storing the ignition on event in computer readable memory; attempting to obtain second data from the data bus; interpreting the obtained second data or absence of second data as either the engine running or not running; if the engine is interpreted to be running, returning the device to attempting to obtain second data from the data bus; and if the engine is interpreted not to be running, generating an ignition off event including a corresponding time of the ignition off event, storing the ignition off event in computer readable memory, and returning the device to the state of sleep.

Also disclosed within the purview of the present invention is a device for generating ignition events in a vehicle equipped with an internal combustion engine, comprising: a data interface connected to a data bus in the vehicle; a processor connected to the data interface; non-transitory computer readable media storing computer readable instructions that, when processed by the processor cause: the data interface to wake; the woken data transceiver to attempt to obtain first data from the data bus; interpretation of the obtained first data or an absence of first data as either the engine running or not running; if the engine is interpreted not to be running, return of the data interface to the state of sleep; and if the engine is interpreted to be running: generation of an ignition on event including a corresponding time of the ignition on event; storage of the ignition on event in the non-transitory computer readable media; the data interface to attempt to obtain second data from the data bus; interpretation of the obtained second data or absence of second data as either the engine running or not running; if the engine is interpreted to be running, return of the data interface to attempting to obtain second data from the data bus; and if the engine is interpreted not to be running, generation of an ignition off event including a corresponding time of the ignition off event, storage of the ignition off event in the non-transitory computer readable media, and return of the data interface to the state of sleep.

Still further disclosed are one or more non-transitory computer readable media comprising computer readable instructions that, when executed by a processor in a device that is connected to a data bus in a vehicle with an internal combustion engine, cause the device to perform the steps of: waking, from a state of sleep; attempting to obtain first data from the data bus; interpreting the obtained first data or an absence of first data as either the engine running or not running; if the engine is interpreted not to be running, returning the device to the state of sleep; and if the engine is interpreted to be running: generating an ignition on event including a corresponding time of the ignition on event; storing the ignition on event in computer readable memory; attempting to obtain second data from the data bus; interpreting the obtained second data or absence of second data as either the engine running or not running; if the engine is interpreted to be running, returning the device to attempting to obtain second data from the data bus; and if the engine is interpreted not to be running, generating an ignition off event including a corresponding time of the ignition off event, storing the ignition off event in computer readable memory, and returning the device to the state of sleep.

### BRIEF DESCRIPTION OF THE DRAWINGS

For clarity, the drawings herein are not necessarily to scale, and have been provided as such in order to illustrate the principles of the subject matter, not to limit the invention.

FIG. 1 is schematic diagram of an ignition event generation device connected to various vehicle components, in accordance with the present invention.

FIG. 2 is a flowchart of a process of the ignition event generation device in accordance with some implementations of the present invention.

FIG. 3 is a flowchart of an alternate process of an ignition event generation device, in accordance with other implementations of the present invention.

### DESCRIPTION OF EMBODIMENTS

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the description is to be regarded in an illustrative, rather than a restrictive, sense.

The detailed descriptions that follow are presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware and software is not always sharp, it being understood by those skilled in the art that the software implemented processes described herein may be embodied in hardware, firmware, software, or any combination thereof. Such processes may be controlled by coded instructions such as in microcode and/or in stored programming instructions readable by a computer or processor.

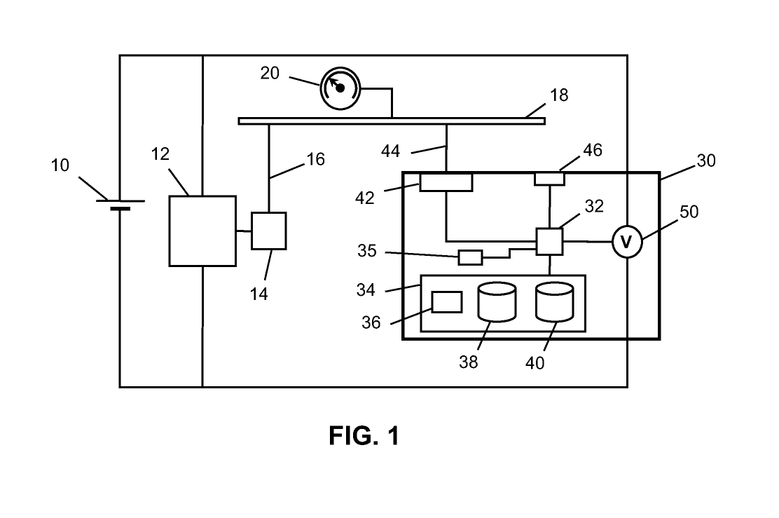

Referring to FIG. 1, there is shown a diagram of various components of a vehicle and some of their connections. The vehicle has a battery 10 which is connected to the engine 12, which in turn is connected to an engine control unit 14. The engine control unit 14 is an electronic control unit that controls the operation of various engine components, such as ignition timing, idle speed, valve timing etc., in order to optimize its operation. It may also include circuits that read values from various sensors attached to the engine, and base its output at least in part on the values that are read. The engine control unit 14 may detect the rpm of the engine, and send a data signal representing the value of the rpm via data connection 16 to vehicle bus 18. An rpm gauge 20 in the vehicle's dashboard may read the rpm data signal from the bus 18 in order to indicate the value of the rpm to the driver of the vehicle.

Also connected to the vehicle bus 18 is an ignition event generation device 30 according to the present invention. Device 30 includes one or more processors 32 connected to one or more computer readable memories 34. The processor 32 may include or be connected to a clock 35 that allows events detected by the processor to be time stamped. The memory 34 stores computer readable instructions 36 that serve to control operation of the device 30. The memory 34 further stores computer readable data in databases 38, 40. Data in database 38 may be data that is stored temporarily during operation of the device 30, and data in database 40 may be data representing ignition on events and ignition off events that are stored for possible future retrieval and analysis. The memories 34 may be of different, non-volatile or volatile forms, and some or all of the memory may be integral with the processor 32.

The ignition event generation device 30 also includes a data transceiver 42 connected to the vehicle bus 18 via data connection 44. The data transceiver 42 can read data signals from the bus 18 and, optionally, can transmit data signals to the bus. The data transceiver 42 may more generally be referred to as a data interface. Data signals read from the bus 18 can be processed by the processor 32 and the results stored in database 40 as ignition on/off events with their corresponding times of occurrence. The results can also be sent to a remote server.

In some embodiments, the processor 32 may be configured to calculate the engine running time from the difference between the recorded times of an ignition on event and the subsequent ignition off event. The engine running times may also be stored in the database 40, for future retrieval.

Also included in the ignition event generation device 30 is a wireless interface 46, for transmitting ignition event data to a remote monitoring server or other remote location. The interface may be a modem or a Wi-Fi interface, for example, although other types of interface may be envisaged. An additional interface may even be included, having a physical connector such that a local, wired connection may be made to the device for retrieving data from database 40.

The ignition event generation device 30 is powered by the vehicle's battery 10. An optional voltage sensing unit 50 may be included in the device 30 to measure the voltage supplied to the device. The voltage sensor 50, if included, is connected to the processor 32 so that any detected changes in the supplied voltage can be acted upon by the processor 32 operating according to the computer readable instructions 36. Changes in the supplied voltage typically occur when the ignition of the vehicle is switched on or off.

In an exemplary embodiment, the ignition event generation device 30, as per a process performed by its processor 32 according to the computer readable instructions 36, wakes on a periodic basis and listens or polls for data on the vehicle data bus 18 for data elements which indicate that the engine 12 is running.

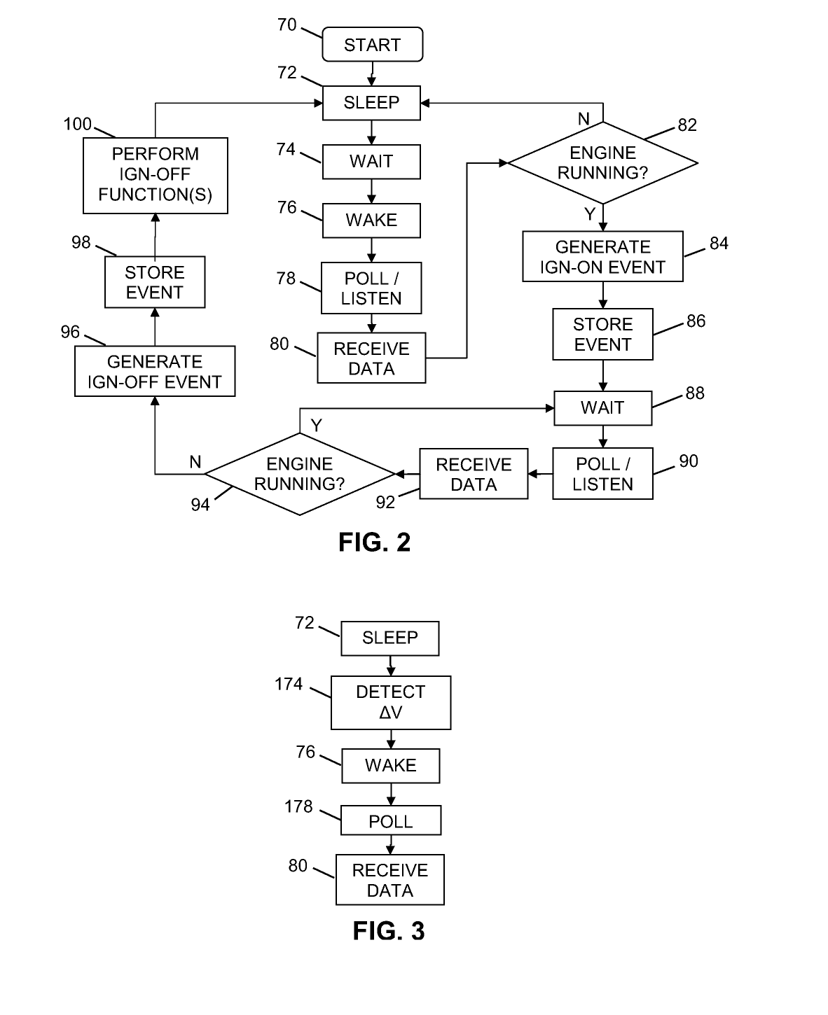

Referring now to FIG. 2, a flowchart is shown of the steps of this process that is performed by the ignition event generation device 30 (via its processor 32). After the process has started, in step 70, the device 30 will, at some point later, enter a sleep mode 72. An advantage of the device 30 sleeping is that it saves power. In the sleep mode, some, but not all, of the circuits in the device 30 are powered down. After a period of waiting, in step 74, the device 30 wakes, in step 76, enabling its circuits that are required for communication with the vehicle data bus 18. The period of waiting may be fixed, variable or follow a predetermined pattern. After the device 30 has awoken, in step 76, it polls or listens for data on the vehicle data bus 18, in step 78. For some types of vehicle bus 18, data may be fed to it spontaneously by the electronic control units, such as engine control unit 14, that are connected to it. For these types of vehicle bus 18, it will suffice for the device 30 to listen for the data, passively. For other types of vehicle bus 18, where the relevant electronic control units do not spontaneously provide data to the bus, then the device 30 must actively poll the bus. Any of the electronic control units that are configured to respond to such a poll will do so, providing the requested data to the bus 18.

Depending on the configuration of the ignition event generation device 30, the device 30 may be configured to listen only; poll only; listen and then only poll if no data is obtained; or listen and/or poll depending on the behavior of the vehicle bus 18. The device 30 may be configurable by the user or the installer, or it may automatically configure itself.

After polling or listening for data in step 78, the device 30 receives the data, if any is present, in step 80. Such data may be stored temporarily, for example, in data store 38. In step 82, the device 30 interprets the data received (or absence thereof) in order to determine whether or not the engine 12 is running. Some bus configurations (e.g. JBUS) only spontaneously report data when the engine is running, so that the presence of any data on the vehicle data bus 18 indicates a running engine 12. However, since it cannot be presupposed that a given vehicle data bus 18 will not report data during an ignition key accessory mode, and a given bus may not spontaneously report values when the engine is running, in general the data from the bus should be read and interpreted, rather than simply detecting that there is data present on it.

If, in step 82, the ignition event generation device 30 determines that the engine 12 is not running, then the process reverts to step 72, which results in the device 30 returning to the sleep mode. If, however, the device 30 determines in step 82 that the engine 12 is running, then an ignition on event is generated, in step 84. In step 86, the ignition on event is stored in database 40 in the device 30. The ignition on event includes the time that the device 30 detected that the ignition had been switched on.

From time to time, on a periodic, semi-periodic, random or algorithmically determined basis, the device 30 repeats the polling or listening to the vehicle data bus 18. In step 88, the device waits for a fixed or variable duration, as the case may be, and then polls or listens for data on the vehicle data bus 18 in step 90. In step 92, the device 30 receives the data, if any, from the bus 18. In step 94, the device 30 interprets the data received (or absence thereof) in order to determine whether or not the engine 12 is running. If the device 30 determines that the engine 12 is running, then the process reverts to step 88, which results in the device 30 returning to the wait mode. If, however, the device 30 determines in step 94 that the engine 12 is not running, then an ignition off event is generated, in step 96. In step 98, the ignition off event is stored in database 40 in the device 30. The ignition off event includes the time that the device detected that the ignition had been switched off. After the ignition has been detected to have been switched off, the device 30 performs whatever other functions it has been programmed to carry out that depend on the ignition off event, if any, in step 100. Such functions may be, for example, setting up timers for following wake events and closing files used for data storage. Following this, the device 30 reverts to the sleep mode, in step 72.

In another exemplary embodiment within the purview of the present invention, the process described above may be modified to consume less power. Where active polling is employed in step 78, energy is used for transmission of the poll to the vehicle data bus 18, which may be undesirable since the vehicle's engine 12 will not be running. Instead of actively polling from time to time, and to overcome the problem of unwanted power consumption, an alternative embodiment may use the level of the power supply to the device 30 to trigger interrogation of the vehicle data bus 18.

Referring now to FIG. 3, we see the relevant part of the process carried out by the device 30 in such an alternate embodiment, where the wait step 74 of FIG. 2 has been replaced with a step 174 in which a voltage change is detected. In step 72, the device 30 enters the sleep mode, as before. Some time later, in step 174, the device 30 detects a voltage surge or a voltage dip, sensed by voltage sensor 50, which senses the voltage supplied to the device. Such a surge or dip in voltage occurs during the transition from a non-running to a running engine. Upon detecting a voltage change, the device 30 wakes up, in step 76, enabling its circuits that are required for vehicle bus communication. In step 178, the device polls the vehicle data bus 18, and the data received from the bus is received in step 80. Step 80 and following steps are the same as the remaining steps 82-100 as shown in FIG. 2.

Although the present invention has been illustrated principally in relation to automobiles subject to fleet management, it also has application in respect of other movable assets. For example, the invention could be applied to aircraft, boats and powered construction equipment.

In the description herein, exemplary embodiments disclosing specific details have been set forth in order to provide a thorough understanding of the invention, and not to provide limitation. However, it will be clear to one having skill in the art that variations to the specific details disclosed herein can be made, resulting in other embodiments that are within the scope of the invention disclosed. Steps in the flowcharts may be performed in a different order, other steps may be added, or one or more may be removed without altering the main function of the system. All values, parameters, and configurations described herein are examples only and actual values of such depend on the specific embodiment. Accordingly, the scope of the invention is to be construed in accordance with the substance defined by the following claims.

What is claimed is:

1. A method for generating ignition events in a vehicle equipped with an internal combustion engine, the method comprising the steps of:
waking, from a state of sleep a device connected to a data bus in the vehicle;
the device, while woken, attempting to obtain first data from the data bus;
interpreting, by a processor in the device, the obtained first data or an absence of first data as either the engine running or not running;
if the engine is interpreted not to be running, returning the device to the state of sleep; and
if the engine is interpreted to be running:
generating an ignition on event including a corresponding time of the ignition on event;
storing the ignition on event in computer readable memory;
attempting to obtain second data from the data bus;
interpreting the obtained second data or absence of second data as either the engine running or not running;
if the engine is interpreted to be running, returning the device to attempting to obtain second data from the data bus; and
if the engine is interpreted not to be running, generating an ignition off event including a corresponding time of the ignition off event, storing the ignition off event in computer readable memory, and returning the device to the state of sleep.

2. The method of claim 1, where the device comprises a data transceiver connected to the data bus.

3. The method of claim 2, wherein the data transceiver is powered down in the state of sleep.

4. The method according to claim 1, further comprising the step of waiting before waking the device.

5. The method according to claim 1, wherein first data is obtained by the device listening for data on the data bus.

6. The method according to claim 1, wherein first data is obtained by the device polling the data bus for data.

7. The method according to claim 1, wherein first data is attempted to be obtained by the device listening for data on the data bus and, if no first data is obtained, polling the data bus for data.

8. The method according to claim 1, further comprising the step of waiting before attempting to obtain second data.

9. The method according to claim 1, wherein second data is obtained by the device listening for data on the data bus.

10. The method according to claim 1, wherein second data is obtained by the device polling the data bus for data.

11. The method according to claim 1, wherein second data is attempted to be obtained by the device listening for data on the data bus and, if no second data is obtained, polling the data bus for data.

12. The method according to claim 1, wherein the device is woken as a result of the processor acting upon a detected fluctuation in voltage of a power supply providing power to the device.

13. The method according to claim 1, further comprising transmitting ignition events to a remote location.

14. The method according to claim 1, further comprising the processor calculating an engine running duration by subtracting the time of the ignition on event from the time of the ignition off event.

15. The method of claim 1 further comprising, after generating the ignition off event, the step of performing, by the device, one or more programmed functions that depend on the ignition off event.

16. A device for generating ignition events in a vehicle equipped with an internal combustion engine, comprising:
a data interface connected to a data bus in the vehicle;
a processor connected to the data interface;
non-transitory computer readable media storing computer readable instructions that, when processed by the processor cause:
the data interface to wake;
the woken data transceiver to attempt to obtain first data from the data bus;
interpretation of the obtained first data or an absence of first data as either the engine running or not running;
if the engine is interpreted not to be running, return of the data interface to the state of sleep; and
if the engine is interpreted to be running:
generation of an ignition on event including a corresponding time of the ignition on event;
storage of the ignition on event in the non-transitory computer readable media;
the data interface to attempt to obtain second data from the data bus;
interpretation of the obtained second data or absence of second data as either the engine running or not running;
if the engine is interpreted to be running, return of the data interface to attempting to obtain second data from the data bus; and
if the engine is interpreted not to be running, generation of an ignition off event including a corresponding time of the ignition off event, storage of the ignition off event in the non-transitory computer readable media, and return of the data interface to the state of sleep.

17. The device according to claim 16, wherein first data is obtained by the data interface:
listening for data on the data bus;
polling for data on the data bus; or
first listening then polling for data on the data bus;
and second data is obtained by the data interface:
listening for data on the data bus;
polling for data on the data bus; or
first listening then polling for data on the data bus.

18. The device according to claim 16, connected to receive power from a battery that is connected to the engine, further comprising a voltage sensor for sensing a voltage of the battery, the computer readable instructions configured to cause the processor to wake the data interface when the voltage sensor detects a fluctuation in voltage.

19. The device according to claim 16, comprising a further interface via which ignition events may be transmitted to a remote location.

20. One or more non-transitory computer readable media comprising computer readable instructions that, when executed by a processor in a device that is connected to a data bus in a vehicle with an internal combustion engine, cause the device to perform the steps of:
waking, from a state of sleep;
attempting to obtain first data from the data bus;
interpreting the obtained first data or an absence of first data as either the engine running or not running;
if the engine is interpreted not to be running, returning the device to the state of sleep; and
if the engine is interpreted to be running:
generating an ignition on event including a corresponding time of the ignition on event;
storing the ignition on event in computer readable memory;
attempting to obtain second data from the data bus;
interpreting the obtained second data or absence of second data as either the engine running or not running;
if the engine is interpreted to be running, returning the device to attempting to obtain second data from the data bus; and
if the engine is interpreted not to be running, generating an ignition off event including a corresponding time of the ignition off event, storing the ignition off event in computer readable memory, and returning the device to the state of sleep.
